(19) United States
(12) Patent Application Publication
(10) Pub. No.: US 2010/0251858 A1
(43) Pub. Date: Oct. 7, 2010

(54) Tool with Pivotally Adjustable Driving Head

(76) Inventor: Chia-Hao Huang, Taiping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/417,042

(22) Filed: Apr. 2, 2009

(51) Int. Cl. B25B 13/46; B25B 23/16

(52) U.S. Cl. 81/60; 81/177.1

(57) ABSTRACT

A tool includes a driving head which is pivotally adjustable with respect to a handle. A connecting device is utilized to selectively keep the driving head retained in an angular position with respect to the handle. The handle includes a hole and a first plurality of teeth extending through the hole. The driving head includes one joining prong including a first through hole which includes a first diametrical section and another joining prong including a second through hole which includes a second diametrical section. Further, a second plurality of teeth extends on the first diametrical section. The connecting device includes an engaging member partially received in the hole and the second diametrical section and selectively engages with the first diametrical section. Further, the engaging member includes a third plurality of teeth which selectively engages with the second plurality of teeth for retaining the driving head in a pivoting position.

### BACKGROUND OF THE INVENTION

1. Field of the Invention

The present invention relates to a tool including a driving head which is pivotally adjustable with respect to a handle and a connecting device which is utilized to selectively keep the driving head retained in an angular position with respect to the handle.

2. Description of the Related Art

TW Pat. No. M291349 shows a prying tool including a handle and a driving head which is pivotally adjustable with respect to the handle. Further, a connecting device is utilized to selectively keep the driving head retained in an angular position with respect to the handle. The driving head includes a joining end engaged with the handle, and the joining end includes two prongs spaced from each other, and one of the prongs includes a side having a first plurality of teeth. The connecting device is engaged in a connecting hole of the handle and includes a second plurality of teeth moveable to selectively engage with the first plurality of teeth in order to retain the driving head with respect to the handle. However, a problem that the prying tool suffers is that the upper side first plurality of teeth and the underside second plurality of teeth fail to keep a secure engagement therebetween when the prying tool is under operation. Another problem is that it is not easy to fabricate the first plurality of teeth from a gap between the two prongs, thus resulting an added cost of manufacturing.

The present invention is, therefore, intended to obviate or at least alleviate the problems encountered in the prior art.

### SUMMARY OF THE INVENTION

According to the present invention, a tool includes a driving head which is pivotally adjustable with respect to a handle. A connecting device is utilized to selectively keep the driving head retained in an angular position with respect to the handle. The handle includes a hole and a first plurality of teeth extending through the hole. The driving head includes one joining prong including a first through hole which includes a first diametrical section and another joining prong including a second through hole which includes a second diametrical section. Further, a second plurality of teeth extends on the first diametrical section. The connecting device includes an engaging member partially received in the hole and the second diametrical section and selectively engages with the first diametrical section. Further, the engaging member includes a third plurality of teeth which selectively engages with the second plurality of teeth for retaining the driving head in a pivoting position.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a tool with pivotally adjustable driving head in accordance with a first embodiment of the present invention.

FIG. 2 is a partial, exploded perspective view of the tool of FIG. 1.

FIG. 3 is a cross-sectional view taken along line 3-3 in FIG. 1.

FIG. 4 is a cross-sectional view taken along line 4-4 in FIG. 1.

FIG. 5 is a cross-sectional view taken along line 5-5 in FIG. 4.

FIG. 6 is an extended cross-sectional view of FIG. 4 and in which a connecting device is operably moved to allow the driving head to be pivoted.

FIG. 7 is a cross-sectional view taken along line 7-7 in FIG. 6 and shows the driving head is adapted to be pivoted to another position.

FIG. 8 is a perspective view of a tool with pivotally adjustable driving head in accordance with a second embodiment of the present invention.

FIG. 9 is an extended perspective view of FIG. 8 and in which the driving head is in another pivoting position.

FIG. 10 is a partial, perspective view of a tool with pivotally adjustable driving head in accordance with a third embodiment of the present invention.

FIG. 11 is an extended perspective view of FIG. 10 and in which the driving head is in another pivoting position.

FIG. 12 is a partial, perspective view of a tool with pivotally adjustable driving head in accordance with a fourth embodiment of the present invention.

FIG. 13 is an extended perspective view of FIG. 12 and in which the driving head is in another pivoting position.

FIG. 14 is a partial, perspective view of a tool with pivotally adjustable driving head in accordance with a fifth embodiment of the present invention.

FIG. 15 is an extended perspective view of FIG. 13 and in which the driving head is in another pivoting position.

### DETAILED DESCRIPTION OF THE PREFERRED EMBODIMENT

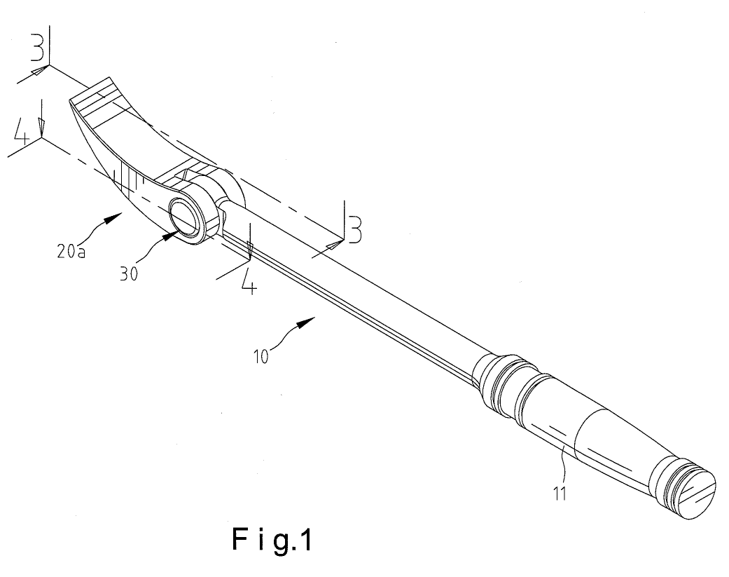

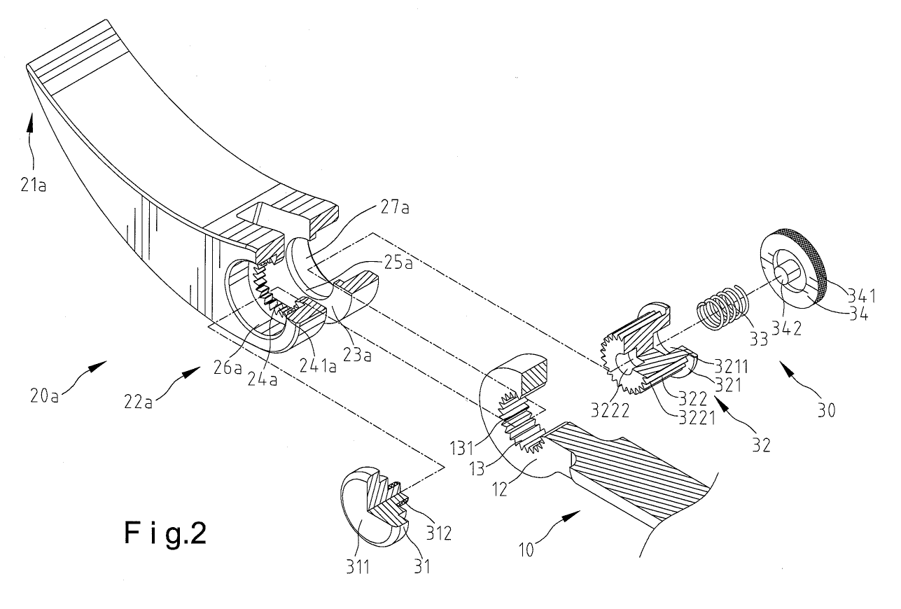

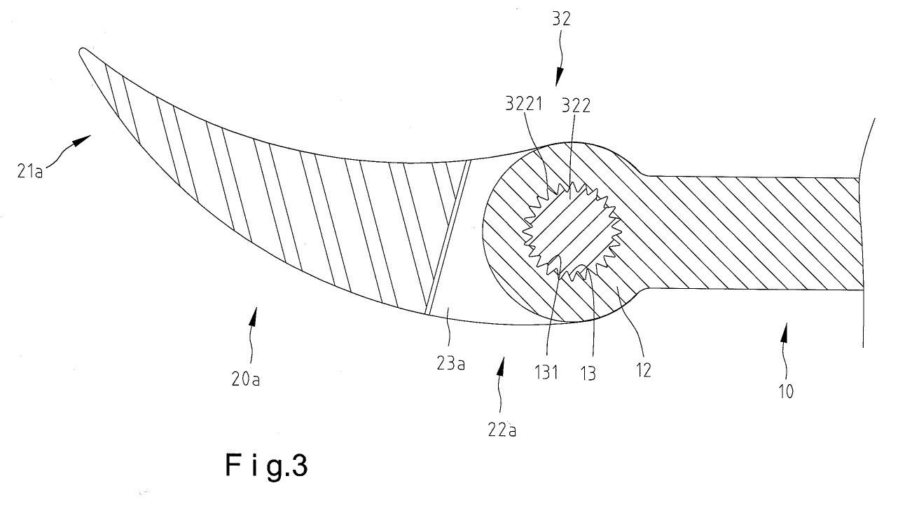

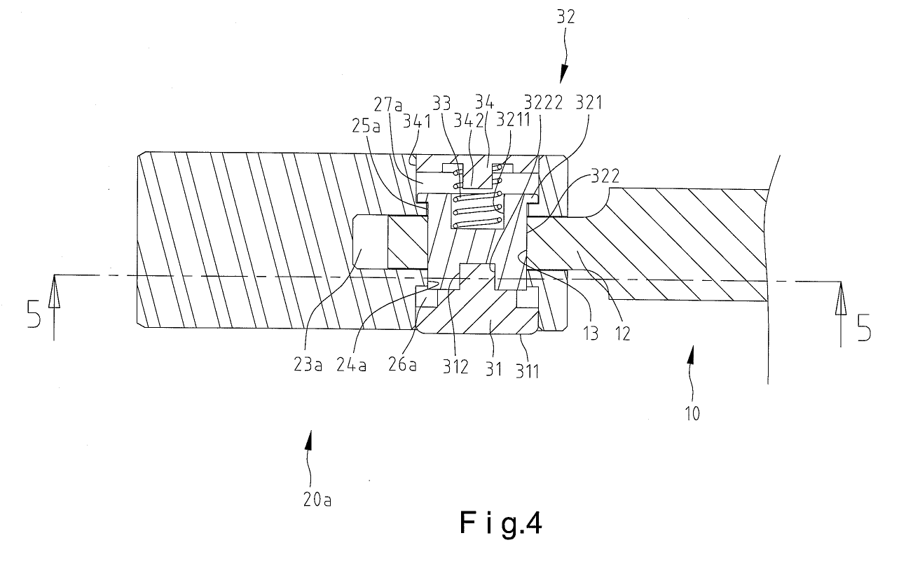

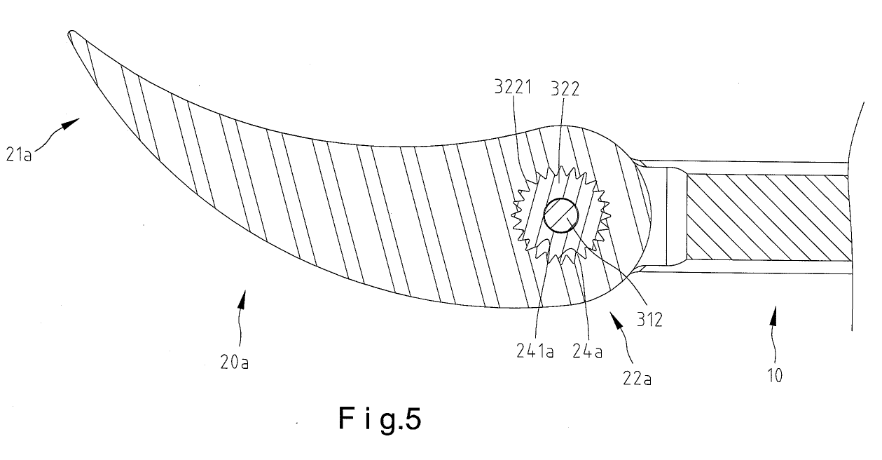

Referring to the FIGS. 1 through 4, a tool in accordance with a first embodiment of the present invention includes a driving head 20a which is pivotally adjustable with respect to a handle 10. The handle 10 includes a gripping end 11 that user can hold and a connecting end 12 for connection with the driving head 20. In the preferred embodiment, the gripping end 11 is opposite to the connecting end 12 and the handle 10 extends axially from the gripping end 11 to the connecting end 12. The driving head 20a includes two joining prongs 22a pivotally receiving the connecting end 12 of the handle 10 in between. In the preferred embodiment, the two joining prongs 22a are opposite and spaced from each other by a gap 23a. The gap 23a is adapted to receive the connecting end 12 of the handle 10. Further, the driving head 20a includes a prying end 21a opposite to the two joining prongs 22a. Additionally, the handle 10 defines an axis and the handle 10 is turned in a plane parallel to the axis and including the axis during the operation thereof.

A connecting device 30 is utilized to selectively keep the driving head 20a retained in an angular position with respect to the handle 10. In the preferred embodiment, the connecting device 30 includes an engaging member 32 partially received in a hole 13 and first and second diametrical sections 24a, 25a. The hole 13 extends transversely to the axis of the handle 10 and through the connecting end 12. The first diametrical section 24a is defined by a first through hole (not numbered) extending through one of the two joining prongs 22a. The second diametrical section 25a is defined by a second through hole (not numbered) extending through the other of the two joining prongs 22a. Preferably, the second diametrical section 25a is coaxial with the first diametrical section 24a. Further, a first plurality of teeth 131 extends through the hole 13 and is formed on the inner periphery of the hole 13. Further, a second plurality of teeth 24b extends longitudinally on the first diametrical section 24a. Further, the engaging member 32 includes a shank 322 and a third plurality of teeth 3221 extending longitudinally on the shank 322. Additionally, the shank 322 is partially received in the hole 13 and first and second diametrical sections 24a, 25a, and with the second diametrical section 25a at least marginally spacing from the third plurality of teeth 3221. Thus, the third plurality of teeth 3221 is in engagement with the first and second plurality of teeth 131 and 241a. Consequently, the driving head 20a is retained in a pivoting position with respect to the handle 10.

The connecting device 30 further includes an elastic member 33 and a retainer 34. The elastic member 33 is retained between the engaging member 32 and the retainer 34. The engaging member 32 may include a first receiving section 3211 extending axially in the shank 322 for receiving an end of the elastic member 33. Additionally, the retainer 34 may include a protrusion 342 for receiving another end of the elastic member 33.

The first and second through hole include third and fourth diametrical section 26a and 27a, respectively, and the retainer 34 is preferably engaged in the fourth diametrical section 27a. The retainer 34 may include a frictional periphery 341 for secure engagement with the fourth diametrical section 27a.

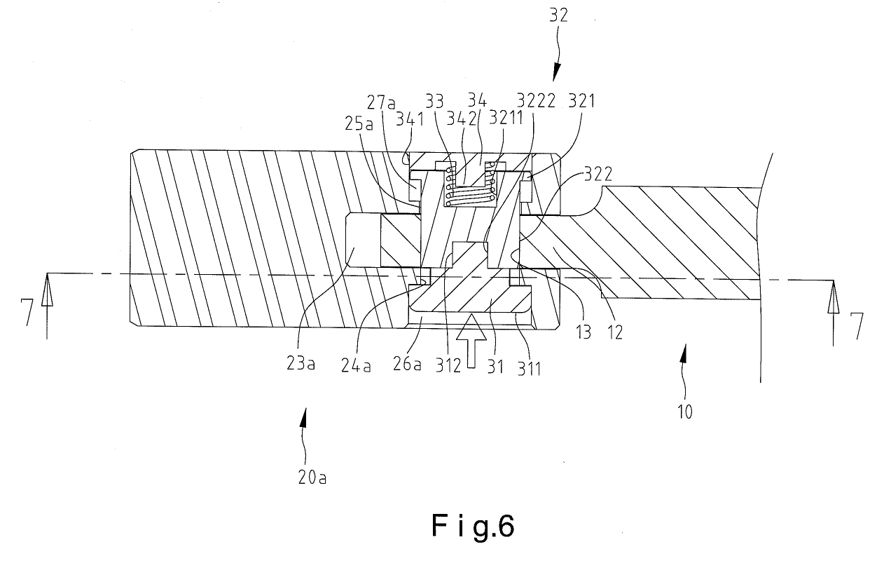

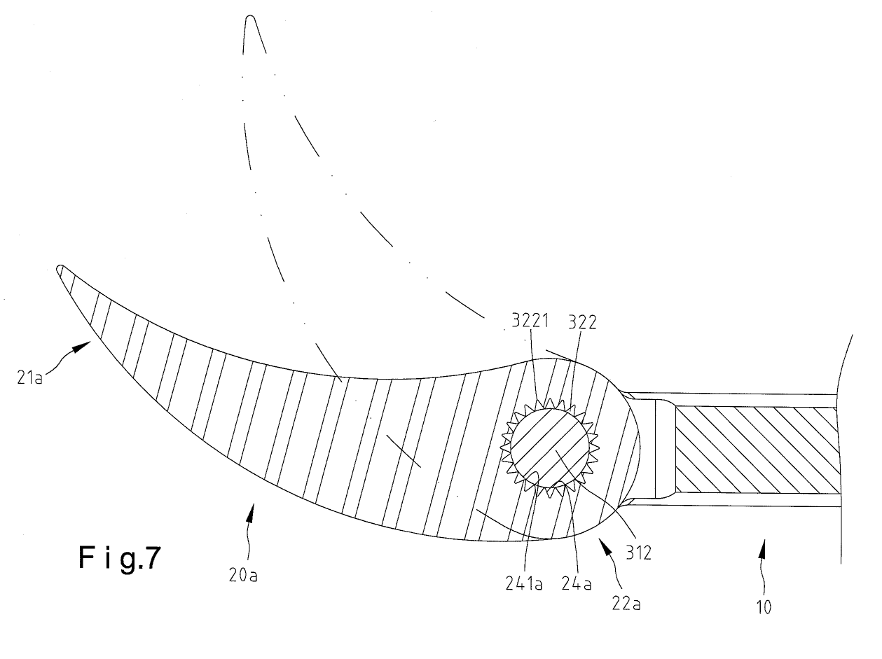

Referring to FIGS. 6 and 7, the shank 322 can be depressed such that the third plurality of teeth 3221 disengages from the second plurality of teeth 241a. Consequently, the driving head 20a is pivotal with respect to the handle 10, and the driving head 20a is pivotal in a plane parallel to the axis of the handle 10 and including the axis. Moreover, the shank 322 can be biasably returned by the elastic member 33 to allow the third plurality of teeth 3221 engages with the second plurality of teeth 241a again. Also, the engaging member 32 may include a rim 321 connected to the shank 322 and received in the fourth diametrical section 27a. The rim 321 has a diametrical size greater than that of the shank 322 and the second diametrical section 25a. Thus, the engaging member 32 is safeguarded against disengagement from the fourth diametrical section 27a.

In addition, the connecting device 30 may include a controller 31 for urging the engaging member 32. The controller 31 is preferably moveably engaged in the third diametrical section 26a. Additionally, the engaging member 32 may include a first end 311 for user to control during operation thereof, and a second end 312 connected to the engaging member 32. Preferably, the engaging member 32 may include a second receiving section 3222 engaging with the second end 312 of the controller 31. Also, the first end 311 may has a diametrical size greater than that of the first diametrical section 24a. Thus, the controller 31 is prevented from being further depressed and disengaged from the first through hole.

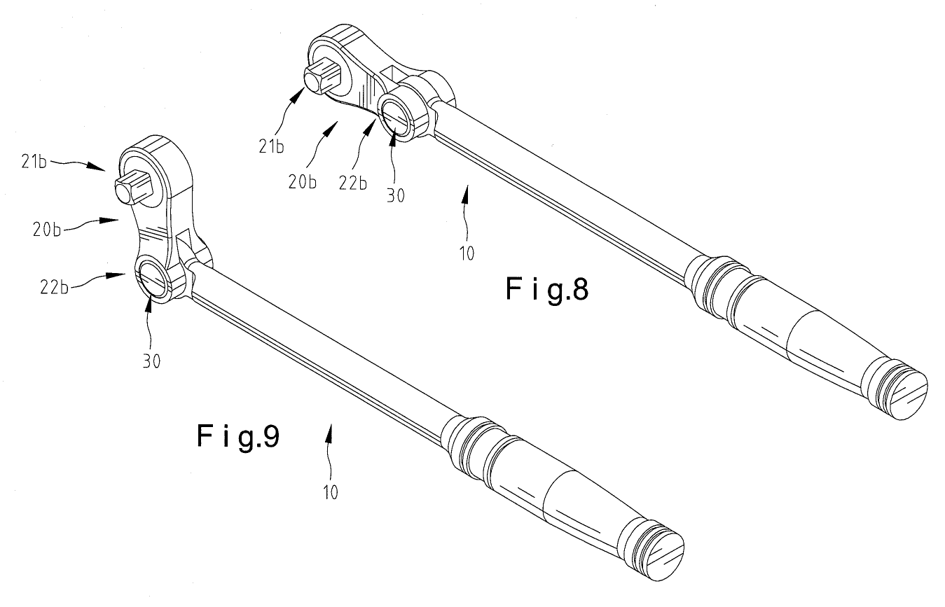

FIGS. 8 and 9 show a tool in accordance with a second embodiment of the present invention. This embodiment is similar to the first embodiment except that it includes a driving head 20b including a ratcheted connector 21b extending transversely therefrom and the handle 10 is turned in a plane substantially orthogonal to the axis of the handle 10 and including the axis during the operation thereof. Further, the driving head 20b is pivotal in a plane parallel to the axis of the handle 10 and including the axis, as the first embodiment.

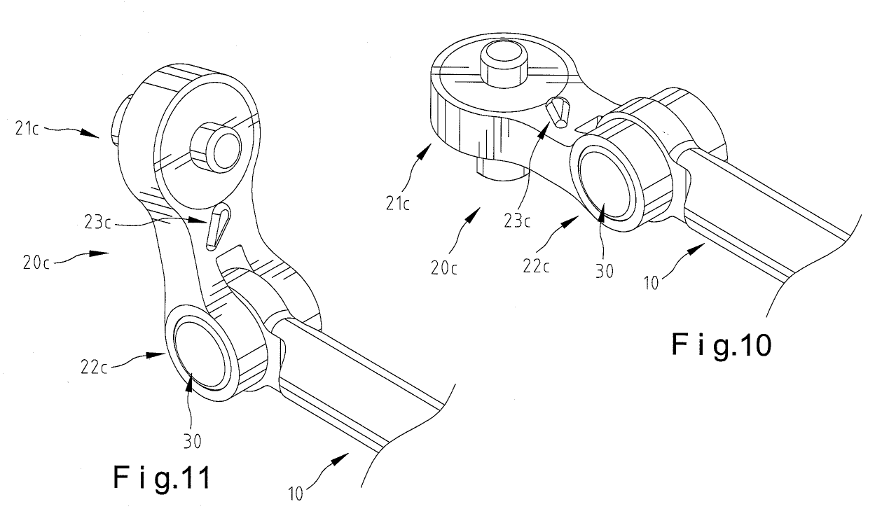

FIGS. 10 and 11 show a tool in accordance with a third embodiment of the present invention. This embodiment is similar to the second embodiment except that it includes a driving head 20c including a ratcheted connector 21c which includes a switch mechanism 23c for changing a driving direction of the ratcheted connector 21c.

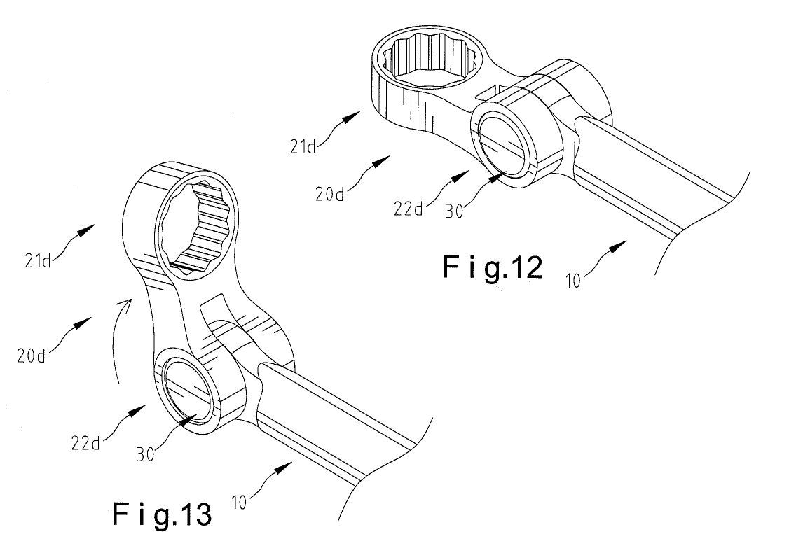

FIGS. 12 and 13 show a tool in accordance with a fourth embodiment of the present invention. This embodiment is similar to the first embodiment except that it includes a driving head 20d including an engaging hole 21d extending transversely therethrough. Further, the handle 10 is turned in a plane substantially orthogonal to the axis of the handle 10 and including the axis during the operation thereof.

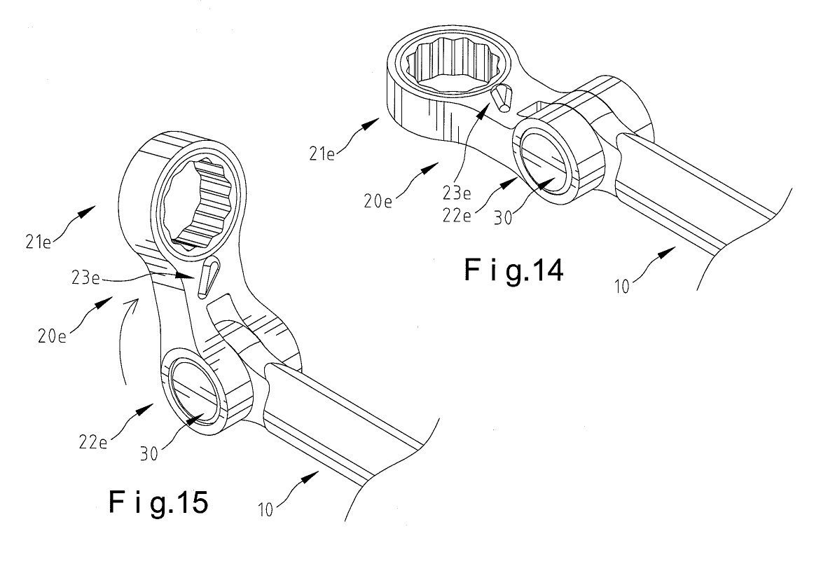

FIGS. 14 and 15 show a tool in accordance with a fifth embodiment of the present invention. This embodiment is similar to the fourth embodiment except that it includes a driving head 20e including an engaging hole 21e which includes a switch mechanism 23c for changing a driving direction of the engaging hole 21e.

While the specific embodiments have been illustrated and described, numerous modifications come to mind without significantly departing from the spirit of invention, and the scope of invention is only limited by the scope of the accompanying claims.

What is claimed is:

1. A tool comprising:
a handle including a connecting end and a hole extending therethrough, the hole defining an inner periphery, and a first plurality of teeth extending through the hole and formed on the inner periphery;
a driving head including two joining prongs opposite to and spaced from each other, the two joining prongs pivotally receiving the connecting end of the handle in between, one of the two joining prongs including a first through hole including a first diametrical section, a second plurality of teeth extending longitudinally on the first diametrical section, the other of two joining prongs including a second through hole including a second diametrical section coaxial with the first diametrical section;
a connecting device including an engaging member, the engaging member including a shank and a third plurality of teeth extending longitudinally on the shank, with the shank partially received in the hole and the second diametrical section, with the second diametrical section at least marginally spacing from the third plurality of teeth, and with the shank selectively engaging with the first diametrical section; and
wherein the third plurality of teeth is in engagement with the first and second plurality of teeth when the engaging member is in the first position and the driving head is retained in a pivoting position with respect to the handle; and
wherein the third plurality of teeth disengages from the second plurality of teeth when the engaging member is in the second position and the driving head is pivotal with respect to the handle.

2. The tool as claimed in claim 1 wherein the connecting device includes an elastic member for biasing the engaging member from the second position to the first position.

3. The tool as claimed in claim 2 wherein the second through hole includes a fourth diametrical section, and wherein the connecting device includes a retainer engaged in the fourth diametrical section, and wherein the elastic member is retained between the engaging member and the retainer.

4. The tool as claimed in claim 3 wherein the fourth diametrical section is of a diametrical size greater than that of the second diametrical section, and wherein the engaging member includes a rim connected to the shank and including a diametrical size greater than that of the shank and the second diametrical section, and wherein the rim is received in the fourth diametrical section and is biasably moved in the fourth diametrical section by the elastic member.

5. The tool as claimed in claim 4 wherein the first through hole includes a third diametrical section, and wherein the connecting device includes a controller moveably engaged in the third diametrical section, and with the controller operably moveable to urge the engaging member between the first and second positions.

6. The tool as claimed in claim 5 wherein the third diametrical section is of a diametrical size greater than that of the first diametrical section, and wherein the controller includes a first end having a diametrical size greater than that of the first diametrical section, and wherein the controller includes a second end connected to the engaging member.

7. The tool as claimed in claim 1 wherein the two joining prongs includes a gap therebetween for receiving the connecting end of the handle.

8. The tool as claimed in claim 3 wherein the engaging member includes a first receiving section extending axially in the shank, and wherein the retainer includes a protrusion, and wherein the elastic element includes one end received in the first receiving section and another end received by the protrusion.

9. The tool as claimed in claim 6 wherein the engaging member includes a second receiving section engaging with the second end of the controller (31).

10. The tool as claimed in claim 1 wherein the handle includes a gripping end opposite to the connecting end, and wherein the handle extends axially from the gripping end to the connecting end and defines an axis, and wherein the driving head is pivotal in a plane parallel to the axis and including the axis.

11. The tool as claimed in claim 1 wherein the driving head includes a prying end opposite to the two joining prongs, wherein the handle defines an axis, and wherein the handle is turned in a plane parallel to the axis and including the axis during the operation thereof.

12. The tool as claimed in claim 1 wherein the driving head includes a ratcheted connector extending transversely therefrom, wherein the handle defines an axis, and wherein the handle is turned in a plane substantially orthogonal to the axis and including the axis during the operation thereof.

13. The tool as claimed in claim 12 wherein the ratcheted connector includes a switch mechanism for changing a driving direction of the ratcheted connector.

14. The tool as claimed in claim 1 wherein the driving head includes an engaging hole extending transversely therethrough, wherein the handle defines an axis, and wherein the handle is turned in a plane substantially orthogonal to the axis and including the axis during the operation thereof.

15. The tool as claimed in claim 14 wherein the engaging hole includes a switch mechanism for changing a driving direction of the engaging hole.
